(19) United States
(12) Patent Application Publication
(10) Pub. No.: US 2022/0374141 A1
(43) Pub. Date: Nov. 24, 2022

(54) PERFORMANCE-ORIENTED GESTURE TYPE DECODING FOR KEYBOARDS

(71) Applicant: ThingThing LTD, London (GB)

(72) Inventor: Francisco J Garcia-Ojalvo, Barcelona (ES)

(21) Appl. No.: 17/663,435

(22) Filed: May 16, 2022

Related U.S. Application Data
(60) Provisional application No. 63/190,794, filed on May 20, 2021.

(51) Int. Cl. G06F 3/04883; G06F 3/0484

(52) U.S. Cl. CPC G06F 3/04883; G06F 3/0484

(57) ABSTRACT

Embodiments include detecting a swipe gesture performed on a virtual keyboard and decoding characters that can form a word, which the user had intended to type by performing the swipe gesture. Embodiments determine candidate words, wherein the trajectory of the swipe gesture includes keys that represent characters in the candidate words. The beam searching involves creating sequences of characters that lead to the candidate words. The characters include ‘starting characters’, and ‘possible characters’ present in the candidate words. The sequences can be constructed based on geometrical information pertaining to the ‘starting characters’, and all the ‘possible characters’, represented by the keys in a swipe trajectory. Embodiments enable pruning of invalid sequences. A sequence is considered as invalid, if the sequence of characters being constructed is unlikely to result in a candidate word.

### CROSS REFERENCE TO RELATED APPLICATION

This application claims priority to and benefit of U.S. Provisional Application Ser. No. 63/190,794 filed on May 20, 2021, the contents of which are incorporated herein by reference.

### TECHNICAL FIELD

The embodiments herein relate to decoding touch inputs on a keyboard and, more particularly, to methods and systems for decoding characters/words in response to an input swipe typing gesture on a keyboard.

### BACKGROUND

One of the primary functions of a keyboard application installed in an electronic device is to display keys that represent characters or letters which are common for a particular language, and decode one or more touch inputs from a user into words. The keyboard application can allow the keys to be displayed in a particular layout on the screen of the electronic device. An issue with the existing keyboard applications can be that they may be constrained by properties of the electronic device, such as the processing latency, memory, computational latency, and so on. It is therefore desirable that the keyboard application utilizes as little as possible Central Processing Unit (CPU) resources and memory of the electronic device. Otherwise, it is likely that the employability of the keyboard application, by the mobile operating system, may be impacted, which in turn can affect the accuracy of decoding.

One of the modes supported by the keyboard application to receive one or more touch inputs from the user, for conversion to words, is “tap typing.” FIG. 1 depicts an example keyboard with QWERTY layout, wherein the user taps the key “n.” In this mode, the user can tap the keys that correspond to the letters of a word. In “tap typing,” the user may likely encounter issues with tapping on the desired key at the exact center of the desired key. Similar issues may also be encountered if the user taps on the sides of the desired key, but the tap of the finger falls on an area of the screen displaying a neighboring key. This may result in a decoding error by the keyboard application, wherein the decoded character may not be the character the user had intended to type through the tap gesture. In case the user is not able to tap on the center of the key, or if a portion of the finger touches a neighboring key while providing the input tap gesture, or if the user fully taps on the neighboring key, then the keyboard application may need to determine or predict the most probable sequence of characters. The process of determination or prediction may be based on one or several dictionaries, and auto-correction models, that run on the electronic device. The dictionaries and the auto-correction models can prevent undesired lag or degradation in the typing experience of the user. The dictionaries and the auto-correction models required for decoding characters/words in “tap typing” may consume a significant amount of memory and processing power of the electronic device.

Other modes supported by advanced keyboard applications can include “swipe typing,” wherein the user can swipe his/her finger across the keyboard layout displayed on the screen of the electronic device. The user may perform a swipe gesture, wherein the finger of the user may pass through a portion of the keyboard displayed on the screen of the electronic device.

FIG. 2 depicts an example keyboard with QWERTY layout, wherein the user performs a swipe gesture (swipe typing) on the keyboard. As depicted in FIG. 2, the swipe gesture follows a path.

However, existing keyboard applications that enable swipe typing may apply heuristics to determine the points that are the best fit for the swipe trajectory. The dictionaries and the spatial probability models required for decoding words in swipe typing may consume a significant amount of memory and processing power of the electronic device. It is therefore desirable to implement swipe typing in keyboard applications in a manner that overcomes these traditional drawbacks.

### BRIEF DESCRIPTION OF THE FIGURES

The embodiments disclosed herein will be better understood from the following detailed description with reference to the drawings, in which:

FIG. 1 depicts an example keyboard with QWERTY layout, wherein the user taps the key ‘n’;

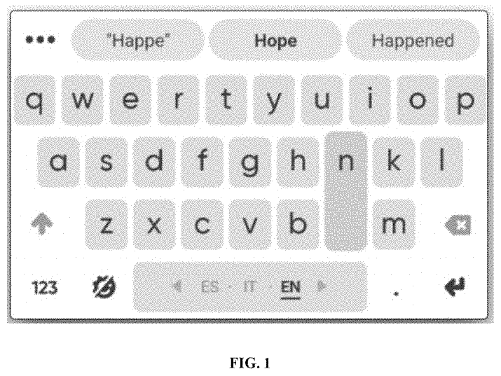

FIG. 2 depicts an example keyboard with QWERTY layout, wherein the user performs a swipe gesture (swipe typing) on the keyboard;

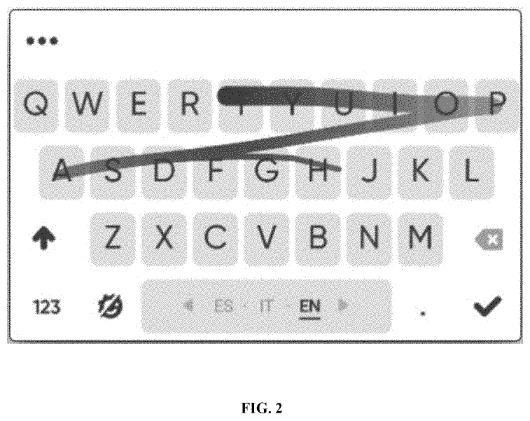

FIG. 3 depicts an example device with a keyboard application configured to decode a candidate word based on a user's swipe gesture, according to embodiments as disclosed herein.

FIG. 4 depicts a method for decoding a candidate word based on a swipe gesture, according to embodiments as disclosed herein;

FIG. 5 depicts an example swipe trajectory of a swipe gesture performed on a keyboard displayed on the display of the example device, according to embodiments as disclosed herein; and

FIG. 6 depicts an example labeling of points in the swipe trajectory, according to embodiments as disclosed herein.

### DETAILED DESCRIPTION OF EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The embodiments herein disclose methods and systems for decoding characters/words in response to an input swipe typing gesture based on beam searching.

The embodiments include detecting a swipe gesture and decoding characters that can form a word which the user had intended to type by performing the swipe gesture. The embodiments include determining a plurality of candidate words, wherein the trajectory of the swipe gesture includes keys that are representing at least one character present at least one candidate word among the plurality of candidate words.

In an embodiment, the candidate words can be determined using one or more dictionaries comprising valid words that may be depicted in a Directed Acyclic Graph (DAG) optimized data structure. In an embodiment, the characters of the candidate words, which may be depicted in the DAG optimized data structure, may be represented using the nodes in the DAG. The starting characters of the candidate words can be represented as disjoint nodes in the DAG. The starting characters of the candidate words can mark the initiation of one or more search paths. Each search path can comprise a chain of nodes representing the characters of a candidate word, wherein the characters in the chain of nodes may be arranged in sequence to create the candidate word.

The embodiments include initially determining the starting characters for the candidate words, and then determining the subsequent characters in the candidate words. The first step can involve creating a sequence, through which the starting character for each candidate word may be determined. For example, if one of the candidate words is ‘happen,’ then the first step may involve creating the sequence through which ‘h’ can be determined to be the starting character for the candidate word ‘happen.’ Thereafter, the embodiments can include determining the subsequent characters, which may be ‘a,’ ‘p,’ ‘p,’ ‘e,’ and ‘n,’ for the candidate word ‘happen.’ At any point in time, if a created sequence of characters does not follow any chain of nodes (search paths) in the DAG, then the sequence can be pruned. For example, if the starting character in a search path is ‘h,’ and if the second character in the search path is ‘t,’ then if ‘ht’ is not a prefix for any valid word in a dictionary or does not follow a chain of nodes in the DAG, then the search path having ‘ht’ may be considered as invalid, and accordingly may be pruned.

Hereafter, the term ‘search paths’ and the term ‘sequences’ have been used interchangeably; wherein the search paths comprises characters of the candidate words represented in chains of nodes in the DAG, and the sequences are created by determining characters and arranging the characters to obtain the candidate words on completion of the sequences. Therefore, a sequence can be considered as valid if the sequence of characters can be mapped to a search path (chain of nodes) in the DAG.

A beam may comprise a plurality of search paths (sequences). The number of search parts in a beam may be determined by the beam width. Each search path in the beam can be constructed by creating a sequence of characters, wherein the sequence is initialized by determining a starting character and lengthening the sequence through inclusion of characters. The embodiments can enable aggressive pruning of invalid search paths (sequences). A search path in the beam can be considered as invalid if the sequence of characters being constructed is unlikely to result in a candidate word. Examples of scenarios where a search path may be invalid is when the characters in the search path are not a prefix for a valid word, when the characters in a search path do not correspond to one or more swipe points in the trajectory of the swipe path, or when the search paths have a probability score lower than the threshold probability value.

The embodiments include configuring parameters such as beam width and a threshold probability value. The beam width can be used for managing the beam search, as the beam width represents the maximum number of search paths that can be included in a beam. For a search path to be included in a beam, the search path (sequence) may need to lead to a candidate word, if the search path is extended by including additional characters. Search paths that are invalid (are not likely to lead to a candidate word), may have a probability that is lower than the threshold probability value, and based on this, any invalid search paths may be pruned. The embodiments include configuring the beam width (maximum number of search paths that can be included in a beam) and the threshold probability value based on data obtained after cross validation with swipe path patterns created during performance of swipe gestures by users.

The decoding process for determining the candidate words can involve utilizing geometrical information pertaining to swipe points in the trajectory of a swipe gesture performed by the user, and keys (letters) in the swipe trajectory that represent characters of the candidate words. In an embodiment, the geometrical information can include an alignment probability score that calculates the probability of the alignment of the swipe points in the swipe trajectory with the keys representing the characters of the candidate words. The alignment probability score may be calculated by using a gaussian probability density function applied to the distance between a specific swipe point and the center of a specific key. In an embodiment, the geometrical information can include a transition probability score that calculates the probability of the swipe points in the swipe trajectory to be in transition from corresponding previous swipe points to the specific key. The transition probability score may be calculated by applying a gaussian probability density function to the angle between the vector previous swipe point current swipe point (also referred to herein as ‘subsequent swipe point’) and the vector previous point center of the specific key.

Based on the geometrical information, the embodiments include constructing the search paths comprising characters of the candidate words. The embodiments include obtaining a plurality of candidate words based on the beam width. The plurality of candidate words can be obtained when the search paths have covered all the swipe points in the trajectory of the swipe gesture. This can involve determining the geometrical information pertaining to all the swipe points in the trajectory of the swipe gesture performed by the user. The embodiments consider a search path as an invalid search path if the search path that comprises the swipe points, has a decoding probability less than a configured threshold, which can be or has been calculated using cross validation with swipe path patterns created during performance of swipe gestures by users. Once the plurality of candidate words have been determined, the embodiments include utilizing a language model for determining the actual word, amongst the plurality of candidate words, that the user had intended to type by performing the swipe gesture.

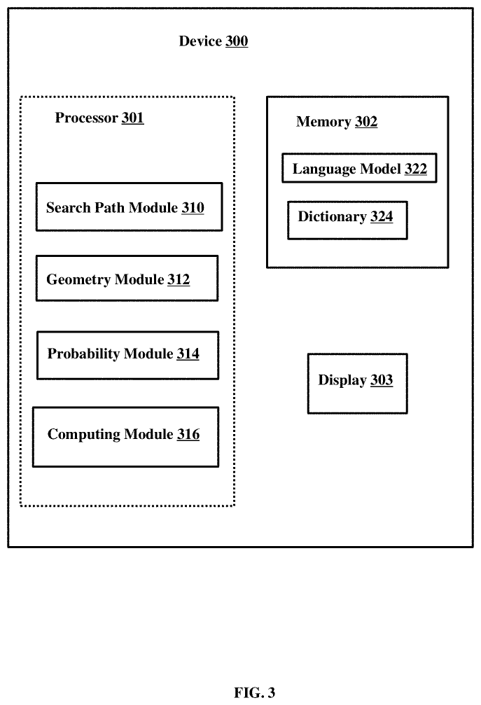

Referring now to the drawings, and more particularly to FIGS. 3 through 6, where similar reference characters denote corresponding features consistently throughout the figures, there are shown embodiments.

FIG. 3 depicts an example device 300 with a keyboard application configured to determine or predict a word that a user had intended to type by performing a swipe gesture, wherein the word may be determined or predicted using beam searching based on geometrical information pertaining to a plurality of points and a plurality of keys in a trajectory of swipe gesture performed by the user, according to embodiments as disclosed herein.

The device 300 may comprise a processor 301, a memory 302, and a display 303. In an example, the device 300 can be a smart phone, a tablet, a laptop, a desktop, and Internet of Things (IoT) device, and so on. The device 300 can include a keyboard application that can display a virtual keyboard on the display 303 of the device 300. The keyboard application can support swipe typing mode. The efficiency and functionalities of the keyboard application may be independent of the processing, computational, and storage capabilities of the device 300.

In an embodiment, the memory 302 can include, but is not limited to, Dynamic RAM (DRAM), Static RAM (SRAM), Programmable Read-Only Memory (PROM), Field-Programmable Gate Arrays (FPGA), Secure Digital (SD) cards, or other types of memory devices. The memory 302 may store a language model 322 or at least one dictionary 324.

A search path module 310 can create the search paths that would include the characters of valid words. The search path module 310 can access the language model 322 and at least one dictionary 324 to include characters for valid words in the search path(s). The maximum number of search paths created by the search path module 310 may be limited to the beam width value.

A geometry module 312 can determine the geometrical information pertaining to swipe points in the trajectory of a swipe gesture performed by the user and the keys (letters) in the swipe trajectory that represent characters of the candidate words. For example, the geometry module 312 may be able to calculate the distance between a specific swipe point and the center of a specific key. The geometry module 312 may also calculate the angle between the vector previous swipe point→current swipe point and the vector previous swipe point→center of the specific key.

A probability module 314 can calculate one or more kinds of probabilities that are relevant to decoding the candidate word. The probability module 314 can access the geometrical information in the geometry module 312 to determine an alignment probability score or a transition probability score for a search path. The probability module 314 can calculate the threshold probability value for a search path, wherein if the probability for any search path is below the threshold probability value, the search path may be considered as invalid, and then pruned. The probability module 314 can also access the memory 302 to calculate the probability of a candidate word appearing in the language model 322 or the at least one dictionary 324.

The computing module 316 may access the data from the probability module 314 and also access the memory 303 to perform one or more functions. One function performed by the computing module 316 can be to check if the probability for a search path is below the threshold probability value. The computing module 316 can also check if the characters in the search path are a prefix for any valid word that is stored in the language model 322 or the at least one dictionary 324. The computing module 316 may also compute a score for each candidate word. The score may be the product of the probability of the search path that has all the characters of the candidate word and the probability of the candidate word appearing in the language module 322 or the at least one dictionary 324. Candidate words may be displayed to the user in a descending order of their score.

The device 300 may have at least one processor 301, which may be coupled to the memory 302, that can perform the functions described in the modules 310, 312, 314, and 316. The processor 301 can determine a plurality of words based on the trajectory of a swipe gesture performed on the virtual keyboard (with a particular layout), which may be visible on the display 303. The swipe trajectory can cover a plurality of keys in the keyboard, displayed on the display 303, representing the characters of the plurality of words. The processor 301 can utilize one or more dictionaries stored in the memory 302, and based on the swipe trajectory, determine the plurality of words. The plurality of words may be referred to as candidate words. In other embodiments, the processor 301 can access the candidate words found in the DAG.

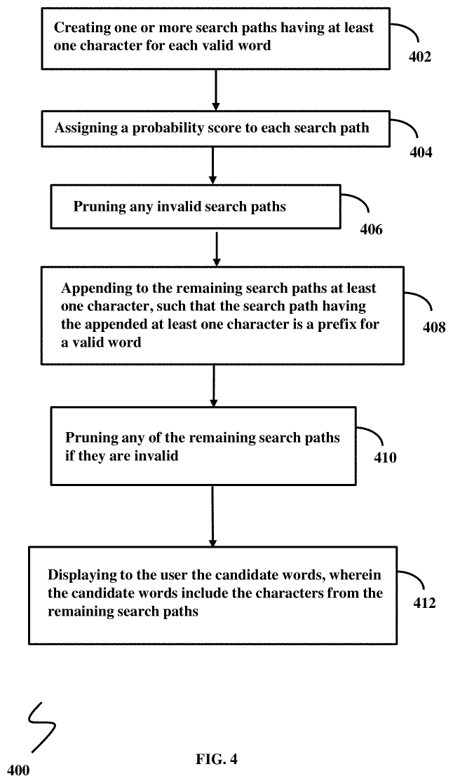

FIG. 4 depicts a method 400 for decoding a candidate word based on a swipe gesture, according to embodiments as disclosed herein. At step 402, one or more search paths may be created, by the search path module 310, where each search path has at least one character of a valid word. The valid word may be a word found in the language model 322 or the dictionary 324.

At step 404, a probability score may be assigned, by the probability module 314, to each search path. The probability score may be an alignment probability score or a transition probability score. The alignment probability score can include the probability that a specific swipe point is aligning to the center of a key representing a specific character. The transition probability score can include the probability that a current swipe point is transitioning from a previous swipe point to the center of the key representing a specific character. The alignment probability score and the transition probability score may be based on certain geographical information regarding the trajectory of the swipe path.

At step 406, any invalid search paths may be pruned. A search may be invalid if at least one of the following occurs: the characters in the search path are not a prefix for a valid word, if the alignment probability score or the transition probability score is lower than a threshold probability value, or if there is at least one character in a search path that does not correspond to any swipe point among the plurality of swipe points. The threshold probability value may also be calculated by the probability module 314.

At step 408, if there are any remaining search paths that have not covered all the swipe points in the trajectory of the swipe points are not covered, the remaining search paths may be appended with at least one character, such that the characters in the remaining search path form a prefix for a valid word.

At step 410, any of the remaining search paths, with the appended character, may be pruned if the search path has an alignment probability score or a transition probability score less than the threshold probability value. The remaining search paths may also be pruned if the characters in it do not correspond to any of the swipe points.

At step 412, the candidate words may be displayed to the user, wherein the candidate words include the characters in the remaining search paths that have survived the pruning process at step 410.

The various actions in method 400 may be performed in the order presented, in a different order or simultaneously. Further, in some embodiments, some actions listed in FIG. 4 may be omitted.

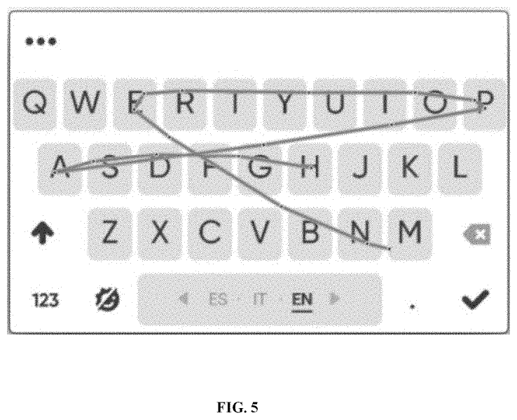

FIG. 5 depicts an example swipe trajectory of a swipe gesture performed on a keyboard displayed on the display 303. As depicted in FIG. 5, the layout of the keyboard displayed on the display 303 is QWERTY. A user of the device 300 may have intended to type a word by performing a swipe gesture on the displayed keyboard. The embodiments include determining the candidate words using one or more dictionaries 324 or a language model. One of the candidate words is likely to be the word that the user had intended to type by performing the swipe gesture. In an example, consider that three words have been determined as candidate words using the one or more dictionaries based on the swipe trajectory depicted in FIG. 5. The three words that have been determined as candidate words are “gas,” “happen,” and “happem.” For simplicity, the example considers that three words have been determined. The embodiments may determine hundreds or thousands of words based on the number of keys on the virtual keyboard that are traversed during the performance of the swipe gesture (and fall in the swipe trajectory).

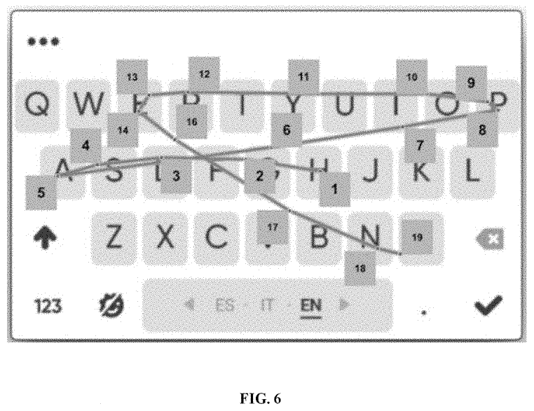

FIG. 6 depicts an example labeling of points in the swipe trajectory. As depicted in FIG. 6, the swipe path includes 19 points, which are labeled as 1, 2, - - - , 19. The position of the points and the distance between the points may depend on the speed at which the user of the device 300 performs the swipe gesture. The processor 301 can record the swipe typing habits of the user in the memory 302, and ascertain the position of the points in the keyboard based on the retrieved records. It is likely that the user may have intended to press a subset of keys, on which the points are labeled. The labeling can allow for construction of search paths by creating a sequence of characters that match the candidate words. Each of the search paths can be initialized by determining the ‘starting characters’ (starting alphabets). Considering the example, two search paths can be initialized as the ‘starting characters’ of the candidate words are either ‘g’ or ‘h’ (assuming that “gas,” “happen,” and “happem” are the only words in the language model 322 or the dictionary 324). The search paths (sequences) can be gradually lengthened by adding further characters (alphabets), until each of the search paths result in creation of a word (such as ‘gas’, ‘happen’, and ‘happem’) that is one of the candidate words. The search paths that are formed by creating sequences of characters that do not match any candidate word can be discarded.

The creation of a search path (sequence) involves determining the ‘starting character’ (‘g’ or ‘h’). The processor 301 can utilize the position of the ‘starting swipe point’ (1), to determine the geometrical information pertaining to the ‘starting character’ and the ‘starting swipe point’. The subsequent swipe points, the specific keys that are representing the possible characters, can be added in sequence to the ‘starting character’ to create a candidate word, and the geometrical information pertaining to the subsequent points and the specific keys can allow for creating the complete search path (sequence). For example, the subsequent swipe points 2-19, and the specific keys ‘s’, ‘a’, ‘p’, ‘e’, ‘n’, and ‘m’, and the geometric information pertaining to the subsequent swipe points and specific keys, can allow for determining amongst all possible candidate words, the word that the user intended to type by performing the swipe gesture.

In an embodiment, the geometrical information pertaining to the ‘starting point’ and the subsequent points, and the ‘starting character’ and the specific keys representing all the possible characters, can be determined based on probabilities of each of the points in the swipe trajectory (for example: 1-19) to be in alignment with at least one of the keys (for example: ‘g’, ‘h’, ‘s’, ‘a’, ‘p’, ‘e’, ‘n’, and ‘m’) that are representing all the possible characters of the candidate words (for example: ‘gas’, ‘happen’, and ‘happem’). In an embodiment, the probabilities can be determined using a Gaussian probability distribution function. The embodiments include adapting the parameters of the Gaussian probability distribution function to the specific dimensions and layout of the keyboard, and the display 303, and the typing habits (swipe typing) habits of the user. The processor 301 can compute the probabilities by applying the Gaussian probability distribution function to the distance between the each of the points in the swipe trajectory and the center of at least one of the keys representing at least one of the possible characters in the candidate words.

In an embodiment, the geometrical information pertaining to the subsequent points, and the ‘starting character’ and the specific keys representing all the possible characters, can be determined based on probabilities of each of the subsequent swipe points to be in a transition from a previous swipe point (including the ‘starting point’) to each of the ‘starting character’ and the specific keys representing all the possible characters of the candidate words. The processor 301 can compute the probabilities by applying the Gaussian probability distribution function to the angles between each of the subsequent swipe points to be in transition between corresponding previous points and the centers of the specific keys representing all the possible characters. In an example, the probability of the subsequent swipe point ‘2’ to be in a transition from the previous swipe point ‘1’ to the center of the key ‘g’ can be computed by applying the Gaussian probability distribution function to the angle between the vector “previous point (1)→current point (2)” and the vector “previous point (1)→center of key ‘g”

Consider that a probability of the swipe point ‘2’ (in the swipe trajectory) in alignment with the key representing the ‘starting character’ h′ (which in present in two candidate words) has been computed. Thereafter, a probability of the swipe point ‘2’ in a transition from the swipe point 1 (previous point) to a key representing a subsequent character ‘a’ is computed. This allows creating a sequence ‘ha’. This sequence can be considered as one of the search paths. The probability (score) assigned to the sequence ‘ha’ is computed by combining the probability of the swipe point ‘2’ in alignment with the key representing the ‘starting character’ ‘h’ and the probability of the swipe point ‘2’ in a transition from the point 1 to the key representing a subsequent character ‘a’. The processor 301 can configure a parameter beam width. In an embodiment, the beam width can represent the maximum number of sequences, i.e., search paths, which can be considered to be leading to the determined candidate words. The processor 301 may be configured to compute the probabilities (scores) of all the search paths. For example, if the beam width is 2, the processor can compute the probabilities of the sequences ‘ha’ and ‘ga’, as both these sequences can lead to the determined candidate words when lengthened or expanded.

The processor 301 can configure a parameter threshold probability for rejecting an invalid search path. The processor 301 may be configured to prune any invalid search paths as the beam searching progresses, i.e., the sequences are lengthened to approach a candidate word. For example, consider that the threshold probability value is configured as 0.2. If the probability for the sequence ‘ha’, computed by combining the probability of the point ‘2’ in alignment with the key representing ‘h’, and the probability of the swipe point ‘2’ in a transition from the point 1 to the key representing ‘a’ is less than 0.2, the search path ‘ha’ will be rejected. Further, while lengthening a sequence of characters representing a search path, if the resulting sequence comprises characters that are not characterized by any of the determined candidate words or valid words, then the search path may be pruned by the processor 301. For example, if the ‘starting character’ is ‘g’, and the subsequent character determined based on the geometrical information pertaining to the point ‘2’ and the key ‘g’ results in creating the sequence ‘gg’, the search path will be pruned. In an embodiment, the processor 301 can configure the beam width and the threshold probability based on data stored in the memory 302. The data is obtained after cross validation with swipe path patterns generated during performance of swipe gestures by the user of the device 300 and/or other users.

Once the search paths reach the destination, or the sequences obtained based on the geometrical information pertaining to all swipe points (in the swipe trajectory) with respect to the keys (in the swipe trajectory) representing all the possible characters present in the candidate words have been determined, the processor 301 can utilize a language model for determining the actual (intended) word, amongst the sequences (candidate words), which the user had intended to type by performing the swipe gesture. If the beam width is ‘1’, i.e., if only the sequence with the highest probability is retained, then usage of the language model will be redundant. For example, considering the beam width to be ‘2’, if the obtained sequences are ‘happen’ and ‘happem’ (considering that a sequence ‘gas’ was pruned as the probability for the sequence ‘gas’ is less than 0.2), the processor can utilize a n-gram language model for predicting that the user had actually intended to type the word ‘happen’, which is one of the candidate words.

The following is a walkthrough of the process of creation of search paths or sequences of characters leading to candidate words, and elimination of search paths or sequences that may not lead to any candidate words or search paths with probability less than the configured threshold. Consider that the determined candidate words are ‘gas’, ‘happen’, and ‘happem’. In an embodiment, the candidate words can be determined based on dictionary-based models or language models. In an embodiment, the probabilities may be assigned to each of the candidate words. In an example, the probability assigned to the candidate word ‘gas’ is 0.3, the probability assigned to the candidate word ‘happen’ is 0.5, and the probability assigned to the candidate word ‘happem’ is 0.2. The embodiments include adding as search paths all the alignments to the ‘starting characters.’ As there are two possible starting characters (‘g’ and ‘h’), two search paths will be obtained. These search paths can be referred to as candidate search paths, and the number of candidate search paths in the beam is based on the configured beam width. The score for each of the search path is the probability of the swipe point ‘1’ being aligned to the center of the key ‘h’ or the key ‘g’.

Candidate Search Paths (Sequences)

1. Character: ‘h’, score: 0.9, previous swipe point: 1, type: alignment

2. Character: ‘g’, score: 0.2, previous swipe point: 1, type: alignment

Thereafter, the geometrical information pertaining to all the subsequent swipe points in the swipe path (starting with the swipe point labeled as ‘2’) can be considered for building new beam (sequence of characters or search paths) based on the current beam.

For each search path or sequence in the current beam, the embodiments include adding characters to the sequence and checking for a possible alignment to the same letter of the search path and a transition to the same letter. For simplicity, it is depicted that all the search paths are processed at the same time.

Candidate Search Paths

1. Prefix: ‘h’, score: 0.45, previous swipe point: 2, type: alignment
2. Prefix: ‘g’, score: 0.4, previous swipe point: 2, type: alignment
3. Prefix: ‘hh’, score: 0.9, previous swipe point: 2, type: transition (discarded)
4. Prefix: ‘gg’, score: 0.9, previous swipe point: 2, type: transition (discarded)

The embodiments include discarding the search paths 3 and 4 are as there are no candidate words starting with ‘hh’ or ‘gg’.

Thereafter, the embodiments include adding all possible transitions to the other (subsequent) characters (based on the candidate words). The embodiments include determining that the character ‘a’ is the subsequent character that can be added in the search paths or sequences, as inclusion of the character ‘a’ to the sequences ‘g’ or ‘h’ can lead to the candidate words.

Candidate Search Paths

1. Prefix: ‘h’, score: 0.45, previous swipe point: 2, type: alignment
2. Prefix: ‘g’, score: 0.4, previous swipe point: 2, type: alignment
3. Prefix: ‘ha’, score: 0.8, previous swipe point: 1, previous letter: ‘h’, type: transition
4. Prefix: ‘ga’, score: 0.5, previous swipe point: 1, previous letter: ‘g’, type: transition

The embodiments include sorting the search paths based on the scores. The embodiments ensure that the number of search paths in the beam do not exceed the beam width.

Candidate Search Paths

1. Prefix: ‘ha’, score: 0.8, previous swipe point: 1, previous letter: ‘h’, type: transition
2. Prefix: ‘ga’, score: 0.5, previous swipe point: 1, previous letter: ‘g’, type: transition
3. Prefix: ‘h’, score: 0.45, previous swipe point: 2, type: alignment
4. Prefix: ‘g’, score: 0.4, previous swipe point: 2, type: alignment

This process is iteratively followed for the subsequent swipe points (3-19) in the swipe trajectory. If the score (probability) of a search path drops below a threshold, the embodiments include discarding (pruning) that search path.

Swipe Point 3: Candidate Search Paths

1. Prefix: ‘ha’, score: 0.8, previous swipe point: 1, previous letter: ‘h’, type: transition
2. Prefix: ‘ga’, score: 0.5, previous swipe point: 1, previous letter: ‘g’, type: transition
3. Prefix: ‘g’, score: 0.3, previous swipe point: 2, type: alignment
4. Prefix: ‘h’, score: 0.2, previous swipe point: 2, type: alignment

Point 4: Candidate Search Paths

1. Prefix: ‘ha’, score: 0.7, previous swipe point: 1, previous letter: ‘h’, type: transition
2. Prefix: ‘ga’, score: 0.4, previous swipe point: 1, previous letter: ‘g’, type: transition

Point 5: Candidate Search Paths

1. Prefix: ‘ha’, score: 0.8, previous swipe point: 1, previous letter: ‘h’, type: transition
2. Prefix: ‘ga’, score: 0.5, previous swipe point: 1, previous letter: ‘g’, type: transition

Point 6: Candidate Search Paths

1. Prefix: ‘hap’, score: 0.8, previous point: 5, previous letter: ‘a’, type: transition
2. Prefix: ‘gas’, score: 0.4, previous point: 5, previous letter: ‘a’, type: transition
3. Prefix: ‘ha’, score: 0.3, previous point: 6, type: alignment
4. Prefix: ‘ga’, score: 0.2, previous point: 6, type: alignment

Point 7: Candidate Search Paths

1. Prefix: ‘hap’, score: 0.7, previous point: 5, previous letter: ‘a’, type: transition
2. Prefix: ‘gas’, score: 0.1, previous point: 5, previous letter: ‘a’, type: transition (discarded)

The embodiments include discarding the search path ‘gas’, as although the search path ‘gas’ has led to a candidate word “gas”, the points 6 and 7 are leaving the key representing the character ‘s’. The same processing continues till the last point (point 19) is reached. The search path ‘gas’ may also be pruned if it has a transition probability score lower than the threshold value.

Point 19: Candidate Search Paths

1. Prefix: ‘happem’, score: 0.8, previous swipe point: 19, type: alignment
2. Prefix: ‘happen’, score: 0.7, previous swipe point: 19, type: alignment

At this stage, the beam may include two search paths or sequences of characters have been obtained that have led to the candidate words ‘happen’ and ‘happem.’ The embodiments include utilizing the language model to determine the word that the user had intended to type. In an embodiment, the language model takes into account the score of the search path and a probability score assigned to each of the search paths by the language model.

If the probability score assigned to the search path or sequence ‘happem’ by the language model is 0.2, then the probability of the user intending to type the candidate word ‘happem’ can be determined based on 0.8*Probability language model (happem)=0.8*0.2=0.16.

If the probability score assigned to the search path or sequence ‘happen’ by the language model is 0.5 then the probability of the user intending to type the candidate word ‘happen’ can be determined based on 0.7*Probability language model (happen)=0.7*0.5=0.35.

Therefore, the final decoding candidates (available for selecting the word the user intended to type) are:

1. Prefix: ‘happen’, score: 0.35, previous point: 19, type: alignment

2. Prefix: ‘happem’, score: 0.16, previous point: 19, type: alignment

The swipe typing decoding may be performed based on geometrical information (instead of speed or custom features), which can significantly lower the Central Processing Unit (CPU) load and memory consumption. The determination or prediction of the word using beam searching can be resilient to abnormal movements of the finger of the user, as all the swipe points in the swipe path (trajectory) and all the possible keys in the swipe path representing the characters of the candidate words may be considered for determining the score (probability) of each search path. The methods and systems may be efficient in terms of flexibility, speed, and memory consumption.

Embodiments herein use the same dictionaries and language models as the tap typing decoding algorithm, which means that there may not be any specific models trained separately for swipe typing decoding, so the dictionaries may be smaller, thereby saving resources in low-end devices. The embodiments disclosed here offer an advantage over neural network-based models, trained on data that needs to be captured from real users or generated automatically, and time-expensive to train.

The way to score each point of the swipe trail in a search path, as disclosed herein, may be much simpler than other existing methods. Embodiments herein may not apply any heuristics and embodiments herein may not require expensive models (like minimum-jerk models) to improve the tolerance to swipe errors, thereby making embodiments as disclosed herein, ideal for low-end devices.

The embodiments disclosed herein can be implemented through at least one software program running on at least one hardware device and performing network management functions to control the network elements.

The embodiment disclosed herein specifies a system for decoding characters/words in response to an input swipe typing gesture based on beam searching. The mechanism allows determining characters that are arranged in a sequence, which is matching a candidate word from amongst a plurality of candidate words, wherein the determined characters are present in at least one candidate word, wherein characters in the plurality of candidate words are represented by keys in the keyboard falling in the trajectory of the swipe gesture, by providing a system thereof. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in at least one embodiment through or together with a software program written in e.g., Very high speed integrated circuit Hardware Description Language (VHDL) another programming language, or implemented by one or more VHDL or several software modules being executed on at least one hardware device. The hardware device can be any kind of device which can be programmed including e.g., any kind of computer like a server or a personal computer, or the like, or any combination thereof, e.g., one processor and two FPGAs. The device may also include means which could be e.g., hardware means like e.g., an ASIC, or a combination of hardware and software means, e.g., an ASIC and an FPGA, or at least one microprocessor and at least one memory with software modules located therein. Thus, the means are at least one hardware means and/or at least one software means. The method embodiments described herein could be implemented in pure hardware or partly in hardware and partly in software. The device may also include only software means. Alternatively, the invention may be implemented on different hardware devices, e.g., using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of embodiments and examples, those skilled in the art will recognize that the embodiments herein can be practiced with modification within the spirit and scope of the claims as described herein.

What is claimed is:

1. A method for decoding at least one candidate word, comprising:
creating at least one search path for each valid word, wherein the at least one search path has at least one character of the corresponding valid word, and wherein each created search path includes at least one of the following:
an alignment probability score, wherein the alignment probability score is the probability of at least one swipe point among a plurality of swipe points in a trajectory of a swipe gesture being aligned to at least one key in a keyboard, wherein the at least one key represents the at least one character; and
a transition probability score, wherein the transition probability score is the probability of a subsequent swipe point being a transition from a previous swipe point to the at least one key representing the at least one character;
pruning the at least one search path if at least one of the following occurs:
the at least one character in the at least one search path leads to an invalid word;
the alignment probability score in the at least one search path is lower than a threshold probability value;
the transition probability score in the at least one search path is lower than the threshold probability value; and
the at least one swipe point does not correspond to the at least one key; and
displaying to the user one or more candidate words, wherein the one or more candidate words include the at least one character in the remaining search paths, wherein the remaining search paths are the search paths that remain after the pruning process.

2. The method of claim 1, further comprising:
appending, to the at least one search path, one or more additional characters, such that the characters in the at least one search includes a prefix of at least one valid word; and
pruning the at least one search path with the appended one or more additional characters if at least one of the following occurs:
the key representing the last character in the prefix does not correspond to the at least one swipe point; and
the alignment probability score or the transition probability score of the at least one search path with the appended one or more additional characters is lower than the threshold probability value.

3. The method of claim 1, wherein the alignment probability score is determined using a gaussian probability density function, wherein the gaussian probability density function is applied to the distance between the at least one swipe point and the center of the at least one key.

4. The method of claim 1, wherein the transition probability score is determined by using a gaussian probability density function that is applied to the angle between the vector of the previous swipe point to the subsequent swipe point, and the vector of the previous swipe point to the center of the at least one key.

5. The method of claim 1, wherein each of the valid words are found in at least one of: a language model and a dictionary.

6. A device, comprising:
a memory, wherein the memory stores one or more instructions;
at least one processor, wherein the at least one processor is coupled to the memory and executes the one or more instructions to result in the performance of at least one of the following steps:
creating at least one search path for each valid word, wherein the at least one search path includes at least one character of the corresponding valid word;
configuring a limit to the maximum number of search paths that can be created;
assigning an alignment probability score to the at least one search path, wherein the alignment probability score is the probability of at least one swipe point among a plurality of swipe points in a trajectory of a swipe gesture being aligned to at least one key in a keyboard, wherein the at least one key represents the at least one character;
assigning a transition probability score to at least one search path, wherein the transition probability score is the probability of a subsequent swipe point being a transition from a previous swipe point to the at least one key representing the at least one character;
appending, to the at least one search path, one or more additional characters such that the characters in the at least one search path form a prefix for a valid word;
pruning the at least one search path if at least one of the following occurs:
the characters in the at least one search path lead to an invalid word;
the alignment probability score for the at least one search path is lower than a threshold probability value;
the transition probability score in the at least one search path is lower than the threshold probability value; and
the at least one swipe point does not correspond to the at least one key; and
displaying to the user one or more candidate words, wherein each candidate word includes the characters in each remaining search path, wherein the remaining search paths include the search paths that remain after the pruning process.

7. The method of claim 6, wherein the alignment probability score is determined by using a gaussian probability density function, wherein the gaussian probability density function is applied to the distance between the at least one swipe point and the center of the at least one key.

8. The method of claim 6, wherein the transition probability score is determined by using a gaussian probability density function, wherein the gaussian probability density function is applied to the angle between the vector of the previous swipe point to the subsequent swipe point, and the vector of the previous swipe point to the center of the at least one key.

9. The method of claim 6, wherein each of the valid words are found in at least one of: a language model and a dictionary.
